(19) United States
(12) Patent Application Publication
(10) Pub. No.: US 2017/0114816 A1
(43) Pub. Date: Apr. 27, 2017

(54) Clip Element, Method for Producing a Component Connection, and Component Connection

(71) Applicant: Bayerische Motoren Werke Aktiengesellschaft, Muenchen (DE)

(72) Inventors: Toni SCHULZ, Muenchen (DE); Magdalena SCHEDER, Muenchen (DE); Johann VAN NIEKERK, Muenchen (DE); Michael BRAUCH, Baldham (DE); Maik HAMMER, Bruckberg (DE)

(21) Appl. No.: 15/401,327

(22) Filed: Jan. 9, 2017

Related U.S. Application Data
(63) Continuation of application No. PCT/EP2015/066753, filed on Jul. 22, 2015.

(30) Foreign Application Priority Data
Aug. 14, 2014 (DE) 10 2014 216 149.5

(51) Int. Cl. F16B 21/08; F16B 2/04

(52) U.S. Cl. CPC F16B 21/086; F16B 2/04

(57) ABSTRACT

A component connection includes a first component which has a through-hole and a clip element which has a shaft portion that has a first end and a second end facing away from the first end, wherein at least one flexurally elastic first form-fitting element protrudes laterally from the first end. The first form-fitting element covers the through-hole on a first face of a wall of the first component. A second form-fitting element protrudes laterally from the second end. The second form-fitting element covers the through-hole on a second wall face opposite the first face. A connection or securing element is inserted into a central hole of the clip element and which has at least one ball. The diameter of the at least one ball corresponds at least to the width of the central hole such that the shaft portion is radially expanded to at least such a width that a press fit is produced between the shaft portion and the through-hole.

### CROSS REFERENCE TO RELATED APPLICATIONS

This application is a continuation of PCT International Application No. PCT/EP2015/066753, filed Jul. 22, 2015, which claims priority under 35 U.S.C. §119 from German Patent Application No. 10 2014 216 149.5, filed Aug. 14, 2014, the entire disclosures of which are herein expressly incorporated by reference.

### BACKGROUND AND SUMMARY OF THE INVENTION

The present invention relates to a clip element for use in producing a component connection, a method for producing the component connection, as well as a component connection so provided.

The object of the invention is to provide a connection element which enables in simple manner a connection between a first component having a through-hole, and other components, as well as to provide a corresponding method for producing a component connection, and a corresponding component connection.

This and other objects are achieved according to embodiments of the present invention.

The starting point for the invention is a “clip element” which is suitable for, and provided for, clipping into a through-hole which is provided in a first component. The clip element according to the invention has a shaft-like portion which can be circular cylindrical in shape, for example. The shaft-like portion in turn has a first end and a second end which faces away from the first end and is at a distance therefrom. At least one flexurally elastic form-fitting element protrudes laterally from the first end. The at least one flexurally elastic form-fitting element can be formed by way of example by a detent lug or by a flexurally elastic form-fitting element protruding brim-shaped or mushroom-shaped away from the first end of the shaft-like portion.

“Flexurally elastic” means in connection with the first form-fitting element that the first form-fitting element can “spring inwards” radially or can be bent elastically so that the clip element can be inserted by its first end into a hole whose diameter is smaller than the diameter of the first end of the shaft-like portion in the non-stressed or relaxed state.

At least one second form-fitting element protrudes laterally away from the second end of the shaft-like portion of the clip element. The second form-fitting element can be likewise formed by way of example by a brim-shaped or mushroom-shaped portion.

According to a further development of the invention, the clip element is made from a plastics material. This can be by way of example a commercially viable injection-molded part. The plastics material should have at least a certain amount of bending elasticity so that the first form-fitting element can be elastically deformed or bent as described above.

According to a further development of the invention, the first form-fitting element is formed flexurally elastic in the direction of the second form-fitting element so that by elastically bending back the first form-fitting element the clip element can be introduced into a hole or through-hole whose width is less than the width of the clip element in the region of the first form-fitting element.

According to a further development of the invention, the clip element has a “central” hole. The central hole can be a hole passing through the entire clip element in the longitudinal direction of the shaft-like portion.

As an alternative, the central hole can also be a blind hole. It can be proposed by way of example that the central hole is a blind hole extending from the first form-fitting element up to a region of the shaft-like portion. As an alternative, the central hole can be a blind hole which extends from the second form-fitting element up to a region of the shaft-like portion.

The method according to the invention for producing a component connection will now be described below. First, a first component is prepared which has a through-hole. The first component can be, for example, a sheet metal component or a plate or the like made from a plastics material, more particularly a fiber-reinforced plastics material.

A “clip element” is further provided which can be constructed as described above. The shaft-like portion of the clip element has a length which corresponds at least to the material thickness or strength of the first component in the region of the through-hole, i.e. at least the “hole depth” of the through-hole.

The clip element is pressed by its first end into the through-hole. Since the flexurally elastic first form-fitting element is dimensioned so that in the unstressed state of the clip element it covers the through-hole, the first form-fitting element has to be deformed as the clip element is pressed into the through-hole. It can be proposed by way of example that the first form-fitting element bends back against the insert direction of the clip element as the clip element is pressed in. Insofar as the first form-fitting element is a brim-shaped or mushroom-shaped form-fitting element protruding radially from the first end of the shaft-like portion, bending back the first form-fitting element can be compared with the movement of a semi-collapsing umbrella. As soon as the first form-fitting element is pressed through the through-hole it springs back into its starting position and covers the through-hole in a form-fitting manner.

A clip element engaged in this way is blocked against the insert direction of the clip element in the through-hole by the at least one first form-fitting element, and the clip element is blocked in the insert direction against being drawn out of the through-hole by the second form-fitting element which protrudes radially away from the second end of the shaft-like portion.

In order to additionally secure the clip element, after pressing the clip element into the through-hole, a connection or securing element can be introduced into the central hole of the clip element. The connection or securing element preferably has at least one ball which is to be inserted into the central hole, wherein the diameter of the ball corresponds at least to the width of the central hole. If the diameter of the ball is slightly larger than the diameter of the central hole, the shaft-like portion is widened out radially slightly as the ball is introduced into the central hole, similar to the case when screwing a screw into a dowel.

As a result of the radial expansion of the clip element through the at least one ball, the clip element is additionally fixed in the through-hole with force-fitting engagement, i.e. the clip element is clamped additionally in the through-hole by the radial expansion. A “press-fit” is thus produced between the clip element and the through-hole.

Two inwardly protruding projections are provided spaced from one another in the longitudinal direction of the shaft-like portion and the at least one ball engages between same. The projections can each be formed by one or more lug-type elements or by a projecting circumferential radially inwardly protruding edge.

Insofar as the central hole is a through-hole it is expedient if two projections spaced from one another in the longitudinal direction of the shaft-like portion are provided which prevent unintended sliding of the ball out in both directions of the shaft-like portion. If the central hole is on the other hand designed as a blind hole the ball obviously only needs to be secured against being drawn out in one direction, i.e. only one such projection need be provided.

According to a further development of the invention, the connection or securing element has two balls connected to one another. The two balls can be connected by way of example directly to one another, e.g. by welding.

According to a further development of the invention, a “function element” protrudes from the at least one ball of the connection or securing element. The function element can be, by way of example, a threaded bolt, a polygon, a hook-like element or the like.

The connection or securing element can be made for example from a metal material, such as, for example, steel, aluminium, copper or the like. As an alternative, the connection or securing element can also be a plastics component, more particularly an injection-molded part.

In order to further improve the “hold” of the connection or securing element in the central hole of the clip element, it is proposed that the connection or securing element is adhesively bonded in the through-hole.

The invention has a practically unlimited number of useful possibilities. The invention can be used in particular in connection with vehicle bodywork construction, if it involves connecting a component provided with a through-hole to another component in a simple commercially viable manner.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram showing the basic principle of the method according to the invention.

FIG. 2 shows different connection and securing elements.

FIG. 3 shows a clip element according to the invention.

FIG. 4 shows a cross-section through a component connection according to an embodiment of the invention.

### DETAILED DESCRIPTION OF THE DRAWINGS

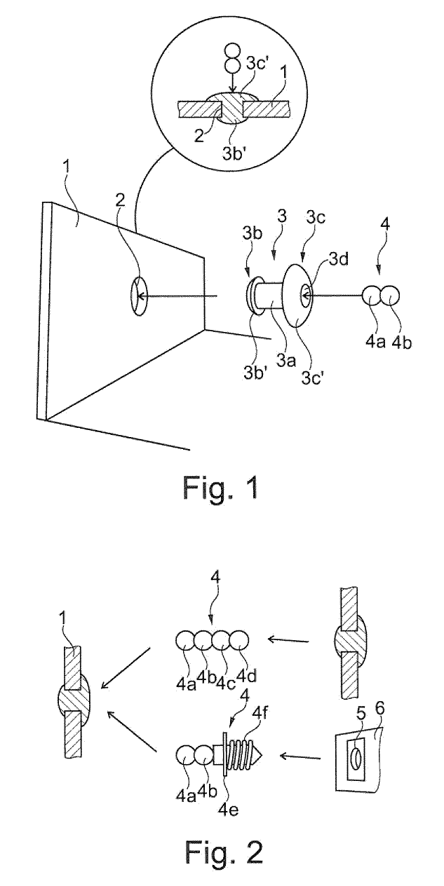

FIG. 1 shows a first component 1 in which a through-hole 2 is provided. A clip element 3 is furthermore shown having a circular cylindrical shaft-like portion 3a. A brim-shaped or mushroom-shaped circumferential portion 3b′, which functions as a first form-fitting element, protrudes radially outwards from a first end 3b of the clip element 3.

A brim-shaped or mushroom-shaped circumferential portion 3c′, which functions as a second form-fitting element, protrudes radially outwards from a second end 3c of the clip element 3 facing away from the first end 3b.

The clip element 3 furthermore has a central through-hole 3d which extends from the first end 3b through the shaft-like portion 3a up to the second end 3c.

At least the brim-shaped or mushroom-shaped portion 3b′, which protrudes radially outwards from the first end 3b of the clip element 3, has a certain softness or bending elasticity. In the non-stressed state of the clip element 3 shown in FIG. 1, the radial diameter of the brim-shaped or mushroom-shaped portion 3b′ is larger than the diameter of the through-hole 2 (see upper illustration of FIG. 1).

In order to introduce the clip element 3 by its first end 3b into the through-hole 2, the brim-shaped or mushroom-shaped portion 3b′ thus has to be bent back slightly in the direction of the second end 3c. As soon as the brim-shaped or mushroom-shaped portion 3b′ has passed the through-hole 2 upon pressing in the clip element 3, the brim-shaped or mushroom-shaped portion 3b′ springs back into the starting position shown in FIG. 1.

In the pressed-in state, the shaft-like portion 3a passes through the through-hole 2. Since the two brim-shaped or mushroom-shaped portions cover the through-hole 2, the clip element 3 is secured in both directions in a form-fitting manner against being drawn out from the through-hole 2, which is particularly apparent from the upper illustration in FIG. 1.

In order to additionally secure the clip element 3 in the through-hole, a connection or securing element 4 can be forced or pressed into the central hole 3d. With the exemplary embodiment illustrated in FIG. 1, the connection or securing element 4 is formed by a “double ball”, i.e. by two balls 4a, 4b, which are connected directly to one another. When the connection or securing element is pressed at least by its ball 4a into the central hole 3d and the diameter of the ball 4a is at least slightly larger than the inner diameter of the central hole 3d, the clip element 3 or the shaft-like portion 3a is expanded radially slightly so that a press-fit is produced between the shaft-like portion 3a and the through-hole 2.

In order to avoid the connection or securing element being accidentally drawn, pressed or slid out from the central hole 3d, it can be proposed that at least one detent element protrudes from a radial inner side of the central hole 3d. The at least one detent element can be formed by way of example by one or more detent lugs arranged spread out in the circumferential direction or by a circumferential detent projection. Preferably, at least two detent elements are provided in the longitudinal direction of the shaft-like portion 3a, whereby the connection or securing element 4 is snap-fitted between same, e.g. by its ball 4a so that the connection or securing element is secured in both directions against accidentally being pressed out, drawn out or slid out from the central hole.

In addition, the connection or securing element 4 can be adhesively bonded in the central hole of the clip element.

FIG. 2 shows two further exemplary embodiments according to the invention. In the upper region of FIG. 2, a connection or securing element 4 is shown which is formed by four balls 4a, 4b, 4c, 4d which are arranged one behind the other in the manner of a pearl chain.

In the lower region of FIG. 2, a connection element 4 is shown which is formed by two balls 4a, 4b connected to one another, a radial projection 4e and a threaded bolt 4f The threaded bolt 4f can be screwed by way of example into an internal thread 5 of a second component 6. The component 1 can be connected to the component 6 very easily in this way.

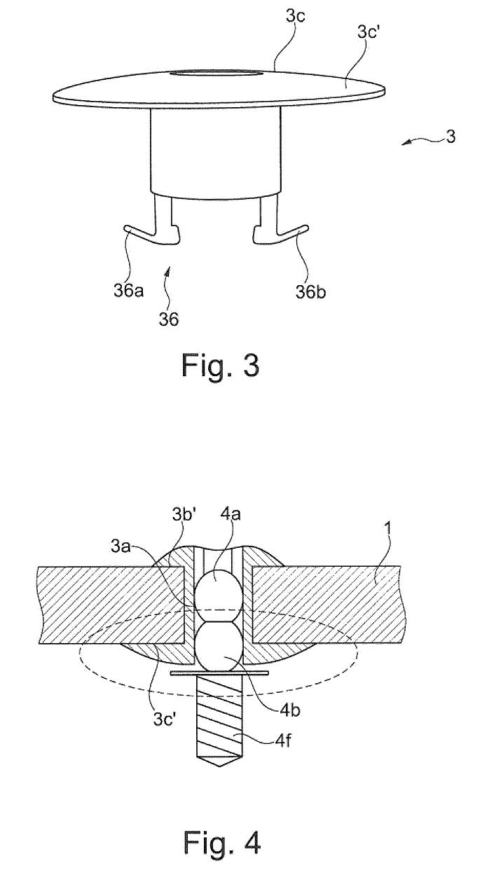

FIG. 3 shows an exemplary embodiment of a clip element according to the invention. The shaft-like portion 3a can be clearly seen. Form-fitting elements designed as detent lugs 36a and 36b protrude on opposite sides away from the first end 3b of the clip element 3. A brim-shaped or mushroom-shaped circumferential form-fitting element 3c′ protrudes away from the second end 3c of the clip element 3 similar to the exemplary embodiment of FIG. 1, 2.

FIG. 4 shows a cross-section through a clip element inserted in a first component 1 and into which a connection or securing element 4 is pushed which has two balls 4a, 4b as well as a threaded bolt 4f protruding outwards from the ball 4b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A clip element, comprising:
a shaft portion which has a first end and a second end which faces away from the first end, wherein
at least one flexurally elastic first form-fitting element projects laterally away from the first end, and
a second form-fitting element projects laterally away from the second end.

2. The clip element as claimed in claim 1, wherein the clip element is made at least in part or completely of plastics.

3. The clip element as claimed in claim 1, wherein the first form-fitting element is configured brim-shaped or mushroom-shaped.

4. The clip element as claimed in claim 1, wherein the first form-fitting element is configured flexurally elastic in a direction of the second form-fitting element, such that by bending back the first form-fitting element the clip element is insertable into a hole whose width is less than a width of the clip element in the region of a first form-fitting element.

5. The clip element as claimed in claim 1, wherein the second form-fitting element is configured brim-shaped or mushroom-shaped.

6. The clip element as claimed in claim 1, wherein the clip element has a central hole which:
(a) extends at least from the first form-fitting element up to the shaft-like portion, or (b) extends at least from the second form-fitting element up to the shaft portion, or (c) passes through the entire clip element in a longitudinal direction of the shaft-like portion.

7. A method for producing a component connection, the method comprising the acts of:
providing a first component having a through-hole;
providing a clip element, the clip element having a shaft portion with a first end and a second end facing away from the first end, wherein a flexurally elastic first form-fitting element projects laterally away from the first end and a second form-fitting element projects laterally away from the second end, and further wherein the shaft portion of the clip element has a length corresponding at least to a material thickness of the first component;
inserting the clip element into the through-hole, wherein
the clip element is pressed via the first end into the through-hole,
the first form-fitting element is bent back when pressed in against an insert direction of the clip element, and
the first form-fitting element, when passing the through-hole, springs back into a starting position and covers the through-hole in a form-fitting manner.

8. The method as claimed in claim 7, further comprising the act of:
introducing a connection or securing element into a central hole of the clip element, the connection or securing element comprising at least one ball having a diameter that corresponds at least to a diameter of the central hole of the clip element.

9. The method as claimed in claim 8, wherein
the diameter of the at least one ball is at least slightly larger than an internal diameter of the central hole so that the shaft portion of the clip element is radially expanded upon inserting the at least one ball.

10. The method as claimed in claim 9, wherein
the diameter of the at least one ball is larger than an internal diameter of the central hole such that a press-fit is produced as the at least one ball is inserted between the shaft portion and the through-hole.

11. The method as claimed in claim 8, wherein the connection or securing element comprises at least two balls or ball-shaped portions connected to one another.

12. The method as claimed in claim 8, further comprising a function element of the connection or securing element, the function element projecting out from the shaft portion of the clip element away from the at least one ball.

13. The method as claimed in claim 12, wherein the function element is a threaded bolt, a polygon or a ball.

14. A component connection, comprising:
a first component having a through-hole;
a clip element, wherein
the clip element has a shaft portion with a first end and a second end facing away from the first end,
at least one flexurally elastic first form-fitting element projects laterally away from the first end and covers the through-hole of the first component on a first side of a wall of the first component, and
a second form-fitting element projects laterally away from the second end and covers the through-hole on a second side of the wall of the first component, the second side being opposite the first side;
a connection or securing element inserted into a central hole formed in the clip element, the connection or securing element having at least one ball, wherein
a diameter of the at least one ball corresponds at least to a diameter of the central hole so that the shaft portion is widened out radially at least to an extent that a press-fit is produced between the shaft portion of the clip element and the through-hole of the first component.

15. The component connection according to claim 14, wherein the connection or securing element is adhesively bonded in the central hole of the clip element.
